(19) United States
(12) Patent Application Publication
(10) Pub. No.: US 2010/0259576 A1
(43) Pub. Date: Oct. 14, 2010

(54) LIQUID DISCHARGING APPARATUS AND LIQUID CHANGING-OVER METHOD

(75) Inventor: Kiyoshi MUKAIYAMA, Shiojiri (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/757,155

(22) Filed: Apr. 9, 2010

(30) Foreign Application Priority Data
Apr. 10, 2009 (JP) 2009-095591

(51) Int. Cl. B41J 29/38

(52) U.S. Cl. 347/14

(57) ABSTRACT

A liquid discharging apparatus includes a discharging section which discharges liquid, a plurality of supply sections which each supply a plurality of different kinds of liquid to the discharging section, a changing-over section which changes over the plurality of supply sections, thereby connecting one of the plurality of supply sections to the discharging section, and a control section which receives instructions for liquid changing-over operation which changes over the connection to the discharging section from a first supply section among the plurality of supply sections to a second different supply section, thereby selecting one of first and second methods for the liquid changing-over operation on the basis of the remaining amount of first liquid acquired by a remaining amount acquisition section which obtains the remaining amount of the first liquid in the first supply section, and controls the execution of the liquid changing-over operation by the selected method.

### BACKGROUND

1. Technical Field

The present invention relates to a liquid discharging apparatus such as an ink discharging apparatus of, for example, an ink jet printer, and in particular, to a liquid discharging apparatus which selectively supplies different kinds of liquid to the same liquid discharging nozzle, and a method for changing over the supply of liquid from a certain kind of liquid to another kind of liquid.

2. Related Art

Using an ink jet printer as example to explain, there is known an ink jet printer which is made such that two kinds of ink of the same color is selectively supplied to a nozzle row corresponding to the color of a printing head through a switching valve (for example, refer to JP-A-2001-187458). Ink which is supplied to the printing head can be changed over from one of the two kinds of ink to the other ink by operating the switching valve.

One typical example of such a kind of printer is a printer which uses, as black ink, ink of the type called “photo black” for photographic printing and ink of the type called “mat black” for other printing and particularly suitable for character printing and selectively supplies the photo black ink and the mat black ink to the same black printing nozzle row.

In the case of changing over ink which is supplied to the printing head from one of the two kinds of ink to the other ink, not only the switching of the switching valve, but also the following maintenance operation of the printing head is performed so that the latter ink is normally discharged from the nozzle row of the printing head. That is, before the switching of the switching valve, the operation (hereinafter, referred to as “first maintenance operation”) for removing the clogging of the relevant nozzles is performed, for example, the operation of sucking ink which is in the interior of the printing head from a nozzle outlet side using a pump or wiping the surface of the nozzle outlet side of the printing head by a rubber blade. When the first maintenance operation ends, the switching valve is switched, so that the latter ink is introduced into the printing head. Thereafter, the operation (hereinafter, referred to as “second maintenance operation”) for replacing the former ink by the latter ink in the printing head, thereby filling the printing head with the latter ink is performed, for example, the operation of discharging (flushing) ink from each nozzle by driving each nozzle, or wiping the surface of the printing head, as described above.

In the first maintenance operation, the former ink is used, and in the second maintenance operation, the latter ink is used. However, if the remaining amount of the former ink in an ink tank is small, even if the remaining amount of the latter ink is sufficient (that is, despite the fact that printing can be executed after the ink changing-over), the first maintenance operation cannot be performed, so that there is a problem that ink cannot be changed over. This is not limited to the ink jet printer, but is a common problem to liquid discharging apparatuses in general, which selectively supply different kinds of liquid to the same liquid discharging nozzle.

### SUMMARY

An advantage of some aspects of the invention is that in the case of performing the changing-over from the first liquid to the second liquid, there is a reduction in the frequency of the changing-over not being possible due to the fact that the remaining amount of the first liquid is small, in other words, enables the liquid changing-over even if the remaining amount of the first liquid is small.

According to a first aspect of the invention, there is provided a liquid discharging apparatus including: a discharging section which discharges liquid; a plurality of supply sections which each supply a plurality of different kinds of liquid to the discharging section; a changing-over section which changes over the plurality of supply sections, thereby connecting one of the plurality of supply sections to the discharging section; and a control section which receives instructions for liquid changing-over operation which changes over the connection to the discharging section from a first supply section among the plurality of supply sections to a second different supply section, thereby selecting one of first and second methods for the liquid changing-over operation on the basis of the remaining amount of first liquid acquired by a remaining amount acquisition section which obtains the remaining amount of the first liquid in the first supply section, and controls the execution of the liquid changing-over operation by the selected method, wherein the liquid changing-over operation by the first method which is performed in a case where the remaining amount of the first liquid is greater than a given first threshold value includes (A) a first maintenance operation which discharges the liquid from the discharging section in a state where the first supply section is connected to the discharging section, (B) changing-over from the first supply section to the second supply section, which is performed by operating the changing-over section, after the first maintenance operation (A), and (C) a second maintenance operation which discharges the liquid from the discharging section in a state where the second supply section is connected to the discharging section, after the changing-over (B), and the liquid changing-over operation by the second method which is performed in a case where the remaining amount of the first liquid is smaller than the given first threshold value includes (D) changing-over from the first supply section to the second supply section, which is performed by operating the changing-over section, and (E) a third maintenance operation which discharges the liquid from the discharging section in a state where the second supply section is connected to the discharging section, after the changing-over (D).

According to the liquid discharging apparatus of the first aspect, one of two methods for the liquid changing-over operation is selected corresponding to the remaining amount of the first liquid. For example, in a case where the remaining amount of the first liquid is greater than the given first threshold value, the first method can be selected, and in a case where the remaining amount of the first liquid is smaller than the first threshold value, the second method can be selected. The first method is a method which uses the first liquid, whereas the second method is a method which does not use the first liquid. In this manner, by selecting the option called the second method, it is possible to perform the liquid changing-over operation even if the remaining amount of the first liquid is small.

Here, the first threshold value may be set to be, for example, a value corresponding to the supply amount of the first liquid which is anticipated in the first maintenance operation (A). Incidentally, an “anticipated supply amount” means the amount of liquid which is projected to be supplied from the supply section in the maintenance operation, and may not accurately coincide with the amount of liquid which is actually used in accordance with the actual execution of the maintenance operation.

The liquid discharging apparatus may be constituted as follows. That is, the control section selects one of the first method and the second method on the basis of the remaining amount of the first liquid and the remaining amount of the second liquid in the second supply section.

According to this configuration, in the case of selecting the method of the liquid discharging operation, not only the remaining amount of the first liquid, but also the remaining amount of the second liquid is considered. For example, in a first case where the remaining amount of the first liquid is greater than the given first threshold value and the remaining amount of the second liquid is greater than a given second threshold value, the first method can be selected, and in a second case where the remaining amount of the first liquid is smaller than the given first threshold value and the remaining amount of the second liquid is greater than a given third threshold value, the second method can be selected. Also, a third case other than the first case and the second can be judged to be an error. In this manner, by considering the remaining amounts of both the first and second liquid, a case where the remaining amount of the first or second liquid is too small, so that it can be more reliably detected that the liquid discharging-over operation cannot be executed by either method, the first and second methods.

Here, for example, the second threshold value may be set to be a value corresponding to the supply amount of the second liquid which is anticipated in (C) (the second maintenance operation), and the third threshold value may be set to be a value corresponding to the supply amount of the second liquid which is anticipated in (E) (the third maintenance operation).

Also, for example, the third threshold value may be set to be a value which is equal to or smaller than the sum of the first threshold value and the second threshold value. The reason is because the anticipated supply amount of the second liquid in the third maintenance operation (E) (the third maintenance operation) may be at most equal to the anticipated supply amounts of the liquid in (A) and (C) (the first maintenance operation and the second maintenance operation) and in fact, may be smaller than it. In this way, the frequency of cases where the liquid changing-over operation is not performed is reduced.

For example, as the third threshold value, a value corresponding to the larger value out of the first and second threshold values may also be adopted. The reason is because the anticipated supply amount of the second liquid in (E) (the third maintenance operation) may be equal to the larger value out of the anticipated supply amounts of the liquid in (A) and (C) (the first maintenance operation and the second maintenance operation). In this way, the frequency of cases where the liquid changing-over operation is not performed is effectively reduced.

Also, the liquid discharging apparatus may also be constituted as follows. That is, the supply amount of the second liquid in (E) (the third maintenance operation) is equal to or smaller than the sum of the supply amount of the first liquid in (A) (the first maintenance operation) and the supply amount of the second liquid in (C) (the second maintenance operation). By this configuration, the amount of ink which is actually used when the liquid changing-over operation is performed is reduced.

Also, the liquid discharging apparatus may also be constituted as follows. That is, (A) (the first maintenance operation) includes discharging the first liquid from the discharging section in order to remove the clogging of the discharging section, (C) (the second maintenance operation) includes discharging the first or second liquid from the discharging section in order to fill the discharging section with the second liquid, and (E) (the third maintenance operation) includes discharging the first or second liquid from the discharging section in order to remove the clogging of the discharging section and fill the discharging section with the second liquid. By this configuration, even when the liquid changing-over operation of any of the first and second methods has been performed, thereafter, the maintenance operation to allow the discharging section to normally discharge liquid is suitably performed.

Here, (E) (the third maintenance operation) may also include a fourth maintenance operation (F) which discharges the second liquid from the discharging section in order to remove the clogging of the discharging section, and after (F), a fifth maintenance operation (G) which discharges the liquid from the discharging section by supplying a supply amount which is smaller than the supply amount of the second liquid in (B) by the supply amount of the second liquid in (F), in order to fill the discharging section with the second liquid.

Also, the liquid discharging apparatus may also be constituted as follows. That is, both (A) (the first maintenance operation) and (E) (the third maintenance operation) include discharging liquid from the discharging section, thereafter, determining whether or not the clogging of the discharging section is removed, and then, discharging liquid again from the discharging section in a case where it is determined that the clogging has been not removed. By this configuration, even when the liquid changing-over operation of any of the first and second methods has been performed, the clogging of the discharging section is reliably removed.

In addition, according to a second aspect of the invention, there is provided a method for performing liquid changing-over operation in a liquid discharging apparatus which includes a discharging section which discharges liquid, a plurality of supply sections which each supply a plurality of different kinds of liquid to the discharging section, and a changing-over section which changes over the plurality of supply sections, thereby connecting one of the plurality of supply sections to the discharging section, where the liquid changing-over operation is for changing over the connection to the discharging section from a first supply section among the plurality of supply sections to a second different supply section, the method including: selecting one of first and second methods for the liquid changing-over operation on the basis of the remaining amount of first liquid in the first supply section; and executing the liquid changing-over operation by the selected method, wherein the liquid changing-over operation by the first method which is performed in a case where the remaining amount of the first liquid is greater than a given first threshold value includes (A) a first maintenance operation which discharges the first liquid from the discharging section in a state where the first supply section is connected to the discharging section, (B) changing-over from the first supply section to the second supply section, which is performed by operating the changing-over section, after the first maintenance operation (A), and (C) a second maintenance operation which discharges the liquid from the discharging section in a state where the second supply section is connected to the discharging section, after the changing-over (B), and the liquid changing-over operation by the second method which is performed in a case where the remaining amount of the first liquid is smaller than the given first threshold value includes (D) changing-over from the first supply section to the second supply section, which is performed by operating the changing-over section, and (E) a third maintenance operation which discharges the liquid from the discharging section in a state where the second supply section is connected to the discharging section, after the changing-over (D).

According to the invention, there is a reduction in the frequency of the changing-over not being possible due to the fact that the remaining amount of ink is small.

### BRIEF DESCRIPTION OF THE DRAWINGS

The invention will be described with reference to the accompanying drawings, wherein like numbers reference like elements.

FIG. 1 is a block diagram showing a functional configuration of an ink discharging apparatus of an ink jet printer related to an embodiment of the invention.

FIG. 2 is a view showing the flow of the overall control of ink changing-over which is performed by a controller in the ink discharging apparatus.

FIG. 3 is a view showing the flow of the decision of an ink remaining amount state, which is performed by the controller.

FIG. 4 is a view showing the flow of a first ink changing-over procedure which is performed by the ink discharging apparatus under control by the controller.

FIG. 5 is a view showing the flow of a second ink changing-over procedure which is performed by the ink discharging apparatus under control by the controller.

FIG. 6 is a view showing a modified example of the flow of the decision of the ink remaining amount state.

FIG. 7 is a view showing a modified example of the flow of the second ink changing-over procedure.

### DESCRIPTION OF EXEMPLARY EMBODIMENTS

Hereinafter, an ink discharging apparatus of an ink jet printer, which is one embodiment of a liquid discharging apparatus according to the invention, will be described with reference to the drawings.

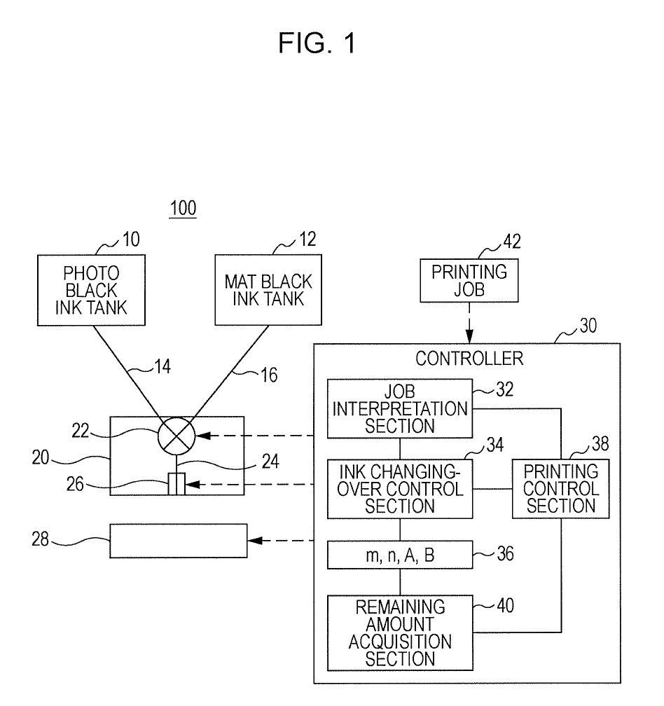

FIG. 1 is a block diagram showing the functional configuration of an ink discharging apparatus of an ink jet printer related to one embodiment of the invention.

An ink discharging apparatus 100 for color printing is provided with, for example, ink tanks for ink of plural colors such as yellow, magenta, cyan, and black. However, in FIG. 1, out of the ink tanks, only a main section related to the black ink tank is shown. As the black ink tank, there are a photo black ink tank 10 which contains photo black ink, and a mat black ink tank 12 which contains mat black ink, as previously described.

Two black ink tanks 10 and 12 (corresponding to “supply sections” in the invention) are respectively connected to a printing head 20 by ink supply tubes 14 and 16. The printing head 20 is provided with a switching valve 22 which is one example of a changing-over section, an ink delivery tube (including also an ink buffer which stores ink in the printing head 20) 24, and a plurality of nozzles 26 for black printing (the ink delivery tube 24 and the nozzles 26, which are portions which are further on the downstream side than the switching valve 22 of the printing head 20, correspond to a “discharging section” in the invention). The switching valve 22 has one outlet and two inlets which are selectively connected to the outlet, and the outlet is connected to the plurality of nozzles 26 through the ink delivery tube 24. Two inlets of the switching valve 22 are respectively connected to outlets of the two black ink tanks 10 and 12 through the ink supply tubes 14 and 16. The switching valve 22 selectively connects one of the two black ink tanks 10 and 12 to the nozzles 26. The connection to the nozzles 26 is changed over from the photo black ink tank 10 to the mat black ink tank 12 or vice versa by switching the switching valve 22. Further, the switching valve 22 may also be located outside the printing head 20.

Also, a head maintenance device 28 is provided and this sucks the nozzles 26 of the printing head 20 from the outside by a pump (not shown) or performs the wiping of the front face (which is a face at which the nozzles 26 are opened, and a face on the lower side in the drawing) of the printing head 20.

A controller 30 is used to control the printing head 20, the head maintenance device 28, a paper feed device (not shown), a carriage (not shown), and so on and is constituted by, for example, a programmed computer, the combination of the programmed computer and a wired logic circuit, or the like. The controller 30 is provided with a job interpretation section 32, an ink changing-over control section (corresponding to a “control section” in the invention) 34, a memory 36, a printing control section 38, and a remaining amount acquisition section 40, as its functional constituents (for example, elements which are realized by executing a program by a computer).

The job interpretation section 32 receives and interprets a printing job 42 from a host apparatus or the like which is outside the ink jet printer. The job interpretation section 32 selects any one of the photo black ink and the mat black ink in accordance with the interpretation results of the printing job 42 (for example, selects the photo black ink if the printing job 42 demands photographic printing, and the mat black ink if the printing job 42 demands character printing), and then, if the selected black ink is a different kind of ink from the black ink which is currently connected to the nozzles 26, the job interpretation section 32 inputs ink changing-over instructions to the ink changing-over control section 34.

The ink changing-over control section 34 receives the ink changing-over instructions from the job interpretation section 32 and controls the driving of the printing head 20, the head maintenance device 28, and so on, thereby controlling the execution of the ink changing-over operation.

The printing control section 38 controls the driving of the printing head 20, the paper feed device (not shown), the carriage (not shown), etc. on the basis of the interpretation results of the printing job 42 from the job interpretation section 32 so that the printing operation according to the printing job 42 is executed. In a case where the ink changing-over is needed prior to the printing, the printing control section 38 waits during the execution of the ink changing-over operation under the control by the ink changing-over control section 34, and after the ink changing-over operation is finished, the printing control section 38 controls the execution of the printing operation.

In the remaining amount acquisition section 40, the ink changing-over control section 34 and the printing control section 38 monitor a signal which drives the nozzles 26, so that the amounts of photo black ink and mat black ink supplied from each of the photo black ink tank 10 and the mat black ink tank 12 to the printing head 20 in the executed ink changing-over operation and the executed printing are predicted by calculation, and the remaining amount values m and n of the photo black ink and the mat black ink which respectively remain in the photo black ink tank 10 and the mat black ink tank 12 are acquired (calculated) on the basis of the supplied amounts of ink. The remaining amount acquisition section 40 stores the acquired remaining amount values m and n of the photo black ink and the mat black ink in the memory 36.

The memory 36 stores the remaining amount value m of the photo black ink and the remaining amount value n of the mat black ink. Further, the memory 36 stores a first threshold value A and a second threshold value B, which will be explained later.

Next, the ink changing-over operation by the ink discharging apparatus 100 configured as described above will be explained.

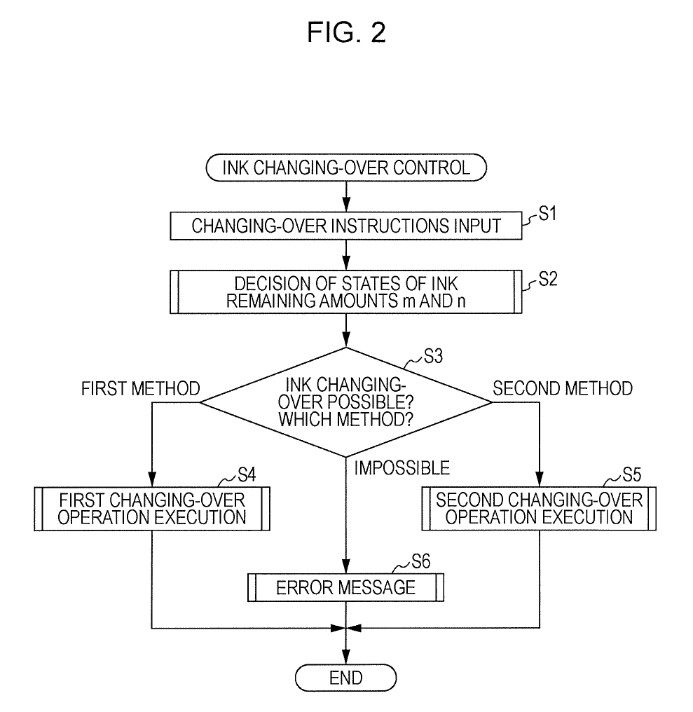

FIG. 2 is a view showing the flow of the overall control of ink changing-over which is performed by the controller 30 shown in FIG. 1.

First, the ink changing-over control section 34 receives the ink changing-over instructions from the job interpretation section 32 (Step S1). Out of the two black ink tanks 10 and 12 shown in FIG. 1, the tank connected to the nozzles 26 at the time of Step S1 is called a “first supply section” in the following explanation, and the other tank is called a “second supply section”. Also, ink which is supplied from the “first supply section” is called “first ink”, and the remaining amount of the “first ink” in the “first supply section” at the time of Step S1 is called the “remaining amount of the first ink”. Also, ink which is supplied from the “second supply section” is called “second ink”, and the remaining amount of the “second ink” in the “second supply section” at the time of Step S1 is called the “remaining amount of the second ink”.

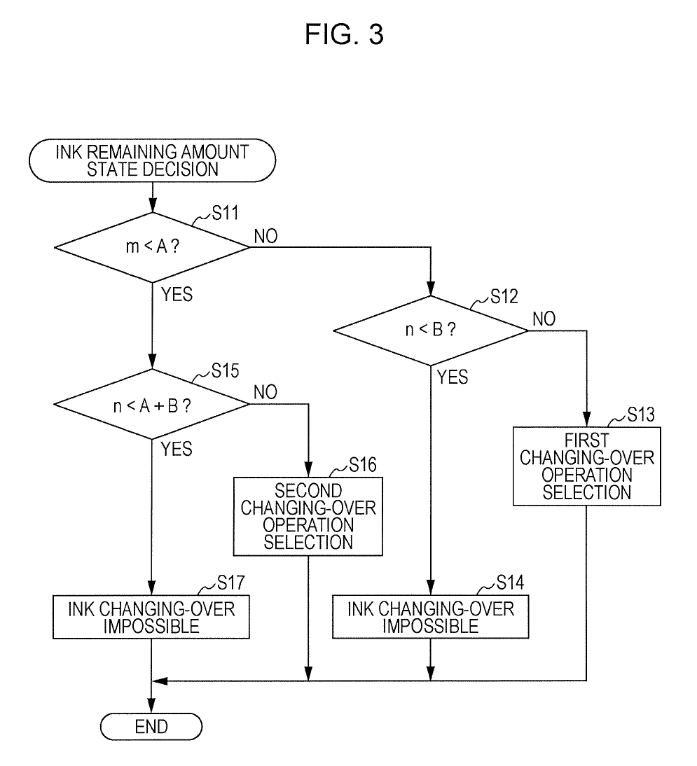

Now, if the ink changing-over control section 34 receives the ink changing-over instructions, the ink changing-over control section 34 reads the remaining amount value m of the first ink and the remaining amount value n of the second ink at this time and the first and second threshold values A and B from the memory 36 and determines to which of four kinds of given states the current states of the remaining amounts of the first and second ink correspond, by a method which will be explained later with reference to FIG. 3, on the basis of these data (Step S2).

As a result of the decision in Step S2, whether or not it is possible to perform the ink changing-over operation is determined, and then, in a case where it is determined that it is possible, one method of the two kinds of given methods, which will be described later, is selected as the method of the ink changing-over operation (Step S3).

In a case where a first method is selected in Step S3, the ink changing-over control section 34 controls the driving of the printing head 20, the head maintenance device 28, and so on, thereby executing the ink changing-over operation by the first method (Step S4) (in the following explanation, the ink changing-over operation by the first method is called “first ink changing-over operation”).

In a case where a second method is selected in Step S3, the ink changing-over control section 34 controls the driving of the printing head 20, the head maintenance device 28, and so on, thereby executing the ink changing-over operation by the second method (Step S5) (in the following explanation, the ink changing-over operation by the second method is called “second ink changing-over operation”).

In a case where in Step S3, it is determined that the ink changing-over operation cannot be executed, the ink changing-over control section 34 holds the execution of the ink changing-over operation and outputs an error message to a display panel (not shown) of the ink jet printer and/or the above-mentioned host apparatus.

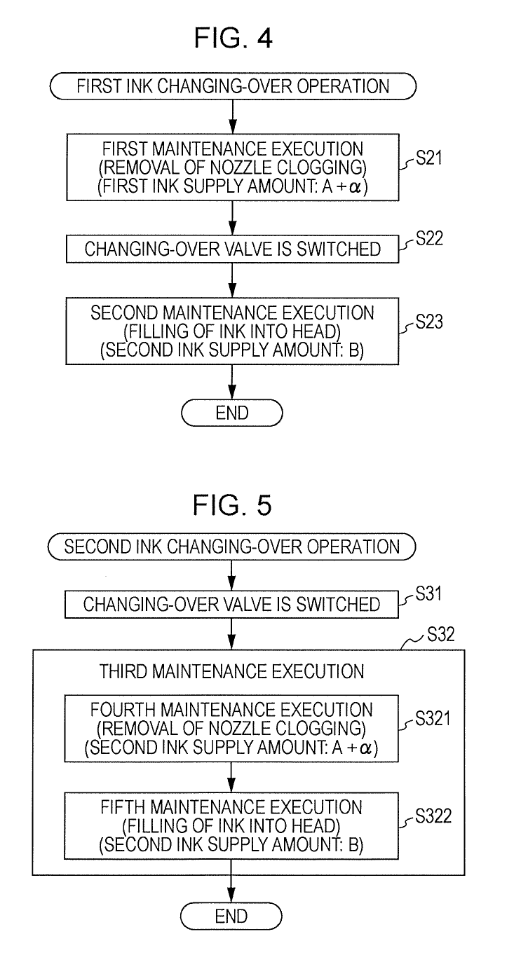

Here, the first ink changing-over operation includes, as will be explained later with reference to FIG. 4, (A) a first maintenance operation which discharges the first ink from the nozzles 26 in a state where the first supply section is connected to the nozzles 26, (B) valve changing-over which changes over the connection to the nozzles 26 from the first supply section to the second supply section by operating the switching valve 22, after the first maintenance operation (A), and (C) a second maintenance operation which discharges the second ink from the nozzles 26 in a state where the second supply section is connected to the nozzles 26, after the valve changing-over (B).

Here, a main object of the first maintenance operation (A) is, for example, to remove the clogging of the nozzles 26. This includes, for example, an operation called “pump suction” which discharges the first ink from the nozzles 26 by sucking the nozzles 26 from the outside by a pump with the use of the head maintenance device 28, an operation called “wiping” which cleans the front face of the printing head 20 by a rubber blade, and the like. In the first maintenance operation (A), ink which is discharged just from the nozzles 26 is the first ink, and first ink which corresponds to the discharged amount of ink is supplied from the first supply section to the printing head 20.

Also, a main object of the second maintenance operation (C) is, for example, to fill the printing head 20 with the second ink. This includes, for example, an operation called “flushing” which discharges ink from the nozzles 26 by driving the nozzles 26, the above-mentioned “wiping”, and the like. In the second maintenance operation (C), since the second ink enters into the printing head 20 in which the first ink exists, ink which is discharged from the nozzles 26 is the first ink, the second ink, or the mixture of them, and the second ink which corresponds to the discharged amount of ink is supplied from the second supply section to the printing head 20.

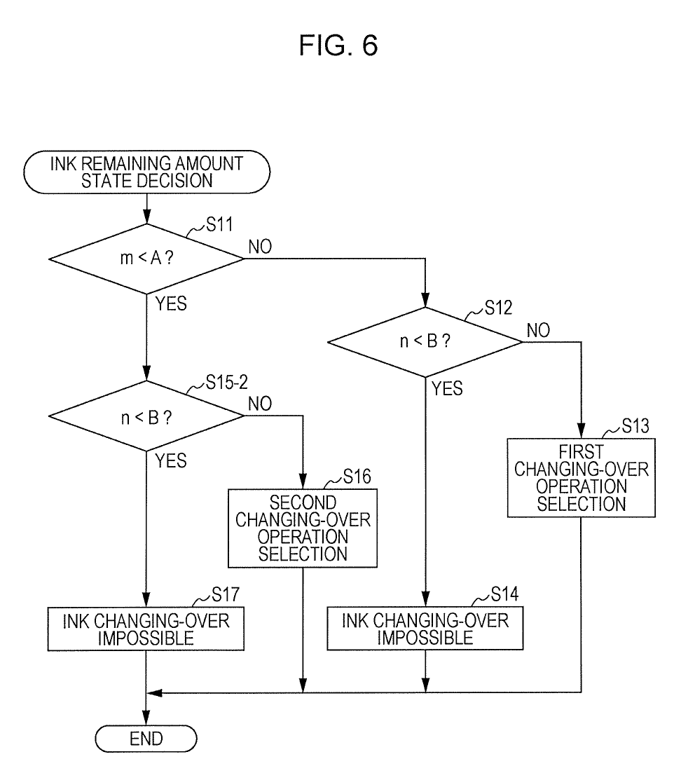

Also, the second ink changing-over operation includes, as will be explained later with reference to FIG. 5, (D) valve changing-over which changes over the connection to the nozzles 26 from the first supply section to the second supply section by operating the switching valve 22, and (E) a third maintenance operation which discharges the second ink from the nozzles 26 in a state where the second supply section is connected to the nozzles 26, after the valve changing-over (D).

Here, the third maintenance operation (E) has two objects, an object to remove the clogging of the nozzles 26 and the other object to fill the printing head 20 with the second liquid. Therefore, in the third maintenance operation (E), for example, the combination of the “pump suction” and the “wiping” may also be included, as in the first maintenance operation (A), the combination of the “flushing” and the “wiping” may also be included, as in the second maintenance operation (C), or both of them may also be included.

In any case, in the third maintenance operation (E), since the second ink enters into the printing head 20 in which the first ink exists, ink which is discharged from the nozzles 26 is the first ink, the second ink, or the mixture of them, and the second ink which corresponds to the discharged amount of ink is supplied from the second supply section to the printing head 20.

FIG. 3 shows the flow of the decision of the ink remaining amount state in Step S2 shown in FIG. 2.

Whether or not the remaining amount m of the first ink is greater than the first threshold value A is determined (Step S11). Here, the first threshold value A is a given value corresponding to the anticipated supply amount of the first ink in the first maintenance operation. Here, the “anticipated supply amount” of the first ink in the first maintenance operation is the amount of first ink which is projected to be supplied from the first supply section to the printing head 20 in a case where the first maintenance operation is ordinarily performed (as will be described later, if the nozzle clogging is not removed by a single execution of the first maintenance operation, the first maintenance operation is repeated again. However, “is ordinarily performed” means that the first maintenance operation is performed, for example, only once), and this is approximately equal to the amount of ink which is discharged from the nozzles 26 when the first maintenance operation is ordinarily performed.

As a result of Step S11, in a case where the remaining amount m of the first ink is equal to or greater than the first threshold value A (NO in Step S11), this means that the first maintenance operation can be executed. In this case, whether or not the remaining amount n of the second ink is greater than the second threshold value B is determined (Step S12). Here, the second threshold value B is a given value corresponding to the anticipated supply amount of the second ink in the second maintenance operation. Here, the “anticipated supply amount” of the second ink in the second maintenance operation is the amount of second ink which is projected to be supplied from the second supply section to the printing head 20 in a case where the second maintenance operation is performed, and this is approximately equal to the amount of ink which is discharged from the nozzles 26 in the second maintenance operation.

As a result of Step S12, in a case where the remaining amount n of the second ink is equal to or greater than the second threshold value B (NO in Step S12), this means that the second maintenance operation can be executed. In this case, the first ink changing-over operation is selected (Step S13).

As a result of Step S12, in a case where the remaining amount n of the second ink is smaller than the second threshold value B (YES in Step S12), this means that neither the first maintenance operation nor the second maintenance operation can be executed, that is, the first ink changing-over operation described above cannot be executed. This also means that the second ink changing-over operation cannot also be executed (the reason is because the remaining amount n of the second ink is too small). Therefore, in this case, it is determined that the ink changing-over operation cannot be executed (Step S14).

As a result of Step S11, in a case where the remaining amount m of the first ink is smaller than the first threshold value A (YES in Step S11), this means that the first maintenance operation cannot be executed. In this case, in order to determine whether or not the second maintenance operation can be executed, whether or not the remaining amount n of the second ink is greater than a third threshold value A+B is determined (Step S15). Here, the third threshold value A+B is a given value corresponding to the anticipated supply amount of the second ink in the third maintenance operation. Also, in this embodiment, as the third threshold value A+B, the sum A+B of the first threshold value A and the second threshold value B is used. The reason is because in this embodiment, as shown in FIG. 5 which will be described later, as the third maintenance operation, an operation (fourth maintenance operation and fifth maintenance operation in FIG. 5) is performed which is substantially equal to the combined operation of the first maintenance operation and the second maintenance operation.

Now, as a result of Step S15, in a case where the remaining amount n of the second ink is equal to or greater than the third threshold value A+B (NO in Step S15), the second ink changing-over operation is selected (Step S16). On the other hand, in a case where the remaining amount n of the second ink is smaller than the third threshold value A+B, it is determined that the ink changing-over operation cannot be executed (Step S17).

FIG. 4 shows the flow of the first ink changing-over operation in Step S4 of FIG. 2.

First, the first maintenance operation is executed (Step S21). In the first maintenance operation, as described above, for example, the “pump suction” and the “wiping” are performed in order to remove the nozzle clogging. In this case, after the first maintenance operation is performed once, whether or not the nozzle clogging has been completely removed may also be checked (although it is not shown in the drawing). Then, if the result of the check is YES, the first maintenance operation is completed with a single execution. However, if the result of the check is NO, in a case where the remaining amount of the first ink is sufficient to additionally perform the first maintenance operation, the first maintenance operation may also be repeated again. In a case where it has been performed, when the first maintenance operation is completed with a single execution, the actual supply amount of the first ink (=the amount of ink actually discharged from the nozzles 26) becomes approximately equal to the first threshold value A, otherwise, the actual supply amount of the first ink becomes a value in which the additional supply amount a due to the repetition is added to the first threshold A. However, in this embodiment, in the processing of determining whether or not the ink changing-over operation as shown in FIG. 3 can be executed, a case where the actual supply amount of the first ink becomes A+α is ignored (in fact, since the frequency is considerably low, even if it is ignored, there is no problem in practical use). Here too, in a case where it is determined that the remaining amount of the first ink is insufficient, so that the additional first maintenance operation cannot be repeated, the second changing-over operation may also be performed.

When the first maintenance operation ends, the switching valve 22 is switched, so that the connection to the nozzles 26 is changed over from the first supply section to the second supply section (Step S22).

After the switching of the switching valve 22, the second maintenance operation is executed (Step S23). In the second maintenance operation, as described above, for example, the “flushing” and the “wiping” are performed in order to fill the printing head 20 with the second ink. The actual supply amount of the second ink at this time (=the amount of ink actually discharged from the nozzles 26) is approximately equal to the second threshold value B.

FIG. 5 shows the flow of the second ink changing-over operation in Step S5 of FIG. 2.

First, the switching valve 22 is switched, so that the connection to the nozzles 26 is changed over from the first supply section to the second supply section (Step S31).

After the switching of the switching valve 22, in a state where the second supply section is connected to the nozzles 26, the third maintenance operation is executed (Step S32). In this embodiment, the third maintenance operation is constituted of two steps. That is, first, the fourth maintenance operation is executed (Step S321), and then the fifth maintenance operation is executed (Step S322).

The fourth maintenance operation is equal to the first maintenance operation shown in FIG. 4 in the operation of the apparatus except for a difference in the kind of ink which is supplied to the printing head 20. Therefore, the actual supply amount of the second ink in the fourth maintenance operation is approximately equal to the supply amount A+α of the first ink in a case where the first maintenance operation is performed. Also, the fifth maintenance operation is equal to the second maintenance operation shown in FIG. 4 in the operation of the apparatus. Therefore, the actual supply amount of the second ink in the fifth maintenance operation is approximately equal to the supply amount B of the second ink in a case where the second maintenance operation is performed.

FIG. 6 shows the flow of a modified processing example of the processing of determining the ink remaining amount state shown in FIG. 3.

The flow of FIG. 6 is different in Step S15-2 from the flow of FIG. 3. That is, in the flow of FIG. 3, the third threshold value (that is, the anticipated amount of the second ink used in the third maintenance operation) is set to be equal to the sum A+B of the first and second threshold values (that is, the sum of the anticipated amounts of the ink used in the first maintenance operation and the second maintenance operation). On the contrary, in the flow of FIG. 6, the third threshold value (that is, the anticipated amount of the second ink used in the third maintenance operation) is set to be equal to a smaller value than the sum A+B of the first and second threshold values, for example, to the larger value out of the first threshold value A and the second threshold value B. In the example of FIG. 6, the third threshold value is set to be equal to the second threshold value B on the premise that the second threshold value B is larger than the first threshold value A (the ink supply amount in the second maintenance operation is greater than the ink supply amount in the first maintenance operation).

The reason why the third threshold value is set in this manner is as follows. That is, according to the control shown in FIGS. 3 and 5, in the third maintenance operation, both the ink discharging for the removal of the nozzle clogging (the fourth maintenance operation: the amount of ink corresponding to the first threshold value A is discharged) and the ink discharging for the filling of ink (the fifth maintenance operation: the amount of ink corresponding to the second threshold value B is discharged) are performed in a state where the second ink is supplied to the printing head 20. However, if the discharging of ink is performed by the amount corresponding to the larger value out of the first threshold value A and the second threshold value B, both these purposes would be achieved at the same time. Therefore, the third threshold value (that is, the anticipated amount of the second ink used in the third maintenance operation) is set to be the larger value (in the example of FIG. 6, the second threshold value B) out of the first threshold value A and the second threshold value B.

Also, according to the reason, in a case where the first threshold value A is larger than the second threshold value B (rather than a case where the second threshold value B is larger than the first threshold value A, which is assumed in FIG. 6), the third threshold value may also be set to be a value which is equal to the first threshold value A.

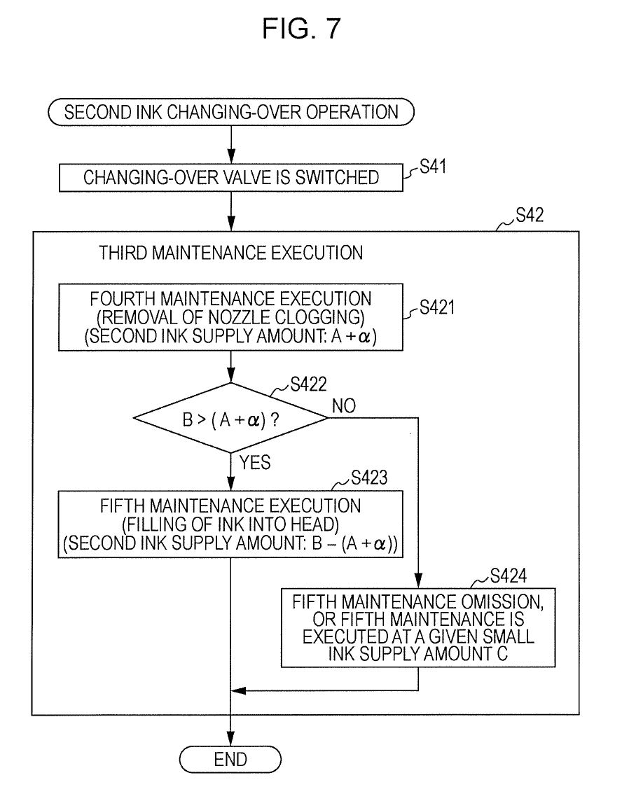

FIG. 7 shows the flow of an operation example in which the second ink changing-over operation of FIG. 5 is modified corresponding to a case where the decision of the ink remaining state is performed in the flow of FIG. 6. (In this case, the first ink changing-over operation can be performed by the flow shown in FIG. 4.)

The flow of FIG. 7 is different in the flow of the third maintenance operation of Step S42 from the flow of FIG. 5. In the third maintenance operation, similarly to the case of the flow of FIG. 5, first, the fourth maintenance operation which includes the “pump suction”, the “wiping”, or the like for the removal of the nozzle clogging is executed (Step S421).

After the end of the fourth maintenance operation, whether or not the actual supply amount A+α of the second ink in the fourth maintenance operation is smaller than the third threshold value B (=the second threshold value B) is determined (Step S422). As a result, if the ink supply amount A+α in the fourth maintenance operation is smaller than the third threshold value B (YES in Step S422), it means that although the purpose of the removal of the nozzle clogging has been sufficiently achieved, the purpose of filling the ink has not been sufficiently achieved. In the case, in order to sufficiently achieve the purpose of filling the ink, the fifth maintenance operation is executed (Step S423). There, the ink corresponding to the amount B-(A+α) of ink in which the ink supply amount A+α in the fourth maintenance operation is subtracted from the third threshold value B is discharged from the nozzles 26.

Also, as a result of the check in Step S422, if the ink supply amount A+α in the fourth maintenance operation is equal to or greater than the third threshold value B (NO in Step S422), it means that both purposes, the removal of the nozzle clogging and the filling of ink, have been sufficiently achieved by the execution of the fourth maintenance operation. In the case, the execution of the fifth maintenance operation is omitted (or, the fifth maintenance operation is executed at a given small ink supply amount C (for example, the minimal ink supply amount for finishing)) (Step S424).

According to the modified examples shown in FIGS. 6 and 7, compared to the control shown in FIGS. 3 and 5, even if the remaining amount of the second ink is small, the ink changing-over operation can be performed, and the amount of ink which is consumed in the ink changing-over operation is smaller.

Although the preferred embodiment of the invention has been described above, this is exemplification for the explanation of the invention and does not intend to limit the scope of the invention only to the embodiment. The invention can be implemented in various aspects which are different from the above-described embodiment, within the scope that does not depart from the essential points of the invention. For example, besides calculating the remaining amount of the ink from the consumed amount of the ink, the amount of ink in the ink tank may also be optically measured, or may also be measured by other means such as the measurement of the weight of the ink tank. Also, the invention is not limited only to the ink changing-over apparatus of the ink jet printer, but can also be applied to other liquid discharging apparatuses or liquid changing-over apparatuses which are applied to other liquid discharging apparatuses.

The entire disclosure of Japanese Patent Application No. 2009-095591, filed Apr. 10, 2009 is incorporated by reference herein.

What is claimed is:

1. A liquid discharging apparatus comprising:
a discharging section which discharges liquid;
a plurality of supply sections which each supply a plurality of different kinds of liquid to the discharging section;
a changing-over section which changes over the plurality of supply sections, thereby connecting one of the plurality of supply sections to the discharging section; and
a control section which receives instructions for liquid changing-over operation which changes over the connection to the discharging section from a first supply section among the plurality of supply sections to a second different supply section, thereby selecting one of first and second methods for the liquid changing-over operation on the basis of the remaining amount of first liquid acquired by a remaining amount acquisition section which obtains the remaining amount of the first liquid in the first supply section, and controls the execution of the liquid changing-over operation by the selected method,
wherein the liquid changing-over operation by the first method which is performed in a case where the remaining amount of the first liquid is greater than a given first threshold value includes
(A) a first maintenance operation which discharges the liquid from the discharging section in a state where the first supply section is connected to the discharging section,
(B) changing-over from the first supply section to the second supply section, which is performed by operating the changing-over section, after the first maintenance operation (A), and
(C) a second maintenance operation which discharges the liquid from the discharging section in a state where the second supply section is connected to the discharging section, after the changing-over (B), and
the liquid changing-over operation by the second method which is performed in a case where the remaining amount of the first liquid is smaller than the given first threshold value includes
(D) changing-over from the first supply section to the second supply section, which is performed by operating the changing-over section, and
(E) a third maintenance operation which discharges the liquid from the discharging section in a state where the second supply section is connected to the discharging section, after the changing-over (D).

2. The liquid discharging apparatus according to claim 1, wherein the first threshold value corresponds to the supply amount of the first liquid which is anticipated in the first maintenance operation (A).

3. The liquid discharging apparatus according to claim 1, wherein the control section
selects the first method in a first case where the remaining amount of the first liquid is greater than the given first threshold value and the remaining amount of the second liquid is greater than a given second threshold value,
selects the second method in a second case where the remaining amount of the first liquid is smaller than the given first threshold value and the remaining amount of the second liquid is greater than a third threshold value which is equal to or greater than the second threshold value, and
determines a third case other than the first case and the second case to be an error.

4. The liquid discharging apparatus according to claim 3, wherein
the second threshold value corresponds to the supply amount of the second liquid which is anticipated in the second maintenance operation (C), and
the third threshold value corresponds to the supply amount of the second liquid which is anticipated in the third maintenance operation (E).

5. The liquid discharging apparatus according to claim 1, wherein the supply amount of the second liquid in the third maintenance operation (E) is equal to or smaller than the sum of the supply amount of the first liquid in the first maintenance operation (A) and the supply amount of the second liquid in the second maintenance operation (C).

6. The liquid discharging apparatus according to claim 1, wherein
the first maintenance operation (A) includes discharging the first liquid from the discharging section in order to remove the clogging of the discharging section,
the second maintenance operation C) includes discharging the first or second liquid from the discharging section in order to fill the discharging section with the second liquid, and
the third maintenance operation (E) includes discharging the first or second liquid from the discharging section in order to remove the clogging of the discharging section and fill the discharging section with the second liquid.

7. The liquid discharging apparatus according to claim 6, wherein the third maintenance operation (E) includes
(F) a fourth maintenance operation which discharges the first or second liquid from the discharging section in order to remove the clogging of the discharging section, and
(G) a fifth maintenance operation which discharges the liquid from the discharging section by supplying the second liquid at a supply amount which is smaller than the supply amount of the second liquid in the changing-over (B) by the supply amount of the second liquid in the fourth maintenance operation (F), in order to fill the discharging section with the second liquid, after the fourth maintenance operation (F).

8. The liquid discharging apparatus according to claim 1, wherein each of the first maintenance operation (A) and the third maintenance operation (E) includes discharging liquid from the discharging section, thereafter, determining whether or not the clogging of the discharging section is removed, and then, discharging again liquid from the discharging section in a case where it is determined that the clogging is not removed.

9. A method for performing liquid changing-over operation in a liquid discharging apparatus which includes a discharging section which discharges liquid, a plurality of supply sections which each supply the plurality of different kinds of liquid to the discharging section, and a changing-over section which changes over the plurality of supply sections, thereby connecting one of the plurality of supply sections to the discharging section, where the liquid changing-over operation is for changing over the connection to the discharging section from a first supply section among the plurality of supply sections to a second different supply section,
the method comprising:
selecting one of first and second methods for the liquid changing-over operation on the basis of the remaining amount of first liquid in the first supply section; and
executing the liquid changing-over operation by the selected method,
wherein the liquid changing-over operation by the first method which is performed in a case where the remaining amount of the first liquid is greater than a given first threshold value includes
(A) a first maintenance operation which discharges the first liquid from the discharging section in a state where the first supply section is connected to the discharging section,
(B) changing-over from the first supply section to the second supply section, which is performed by operating the changing-over section, after the first maintenance operation (A), and
(C) a second maintenance operation which discharges the liquid from the discharging section in a state where the second supply section is connected to the discharging section, after the changing-over (B), and
the liquid changing-over operation by the second method which is performed in a case where the remaining amount of the first liquid is smaller than the given first threshold value includes
(D) changing-over from the first supply section to the second supply section, which is performed by operating the changing-over section, and
(E) a third maintenance operation which discharges the liquid from the discharging section in a state where the second supply section is connected to the discharging section, after the changing-over (D).
